(19) United States
(12) Patent Application Publication
(10) Pub. No.: US 2026/0192276 A1
(43) Pub. Date: Jul. 9, 2026

(54) Method for Controlling a Distributed Control System

(71) Applicant: COVESTRO DEUTSCHLAND AG, Leverkusen (DE)

(72) Inventors: Inga Wolf, Bergisch Gladbach (DE); Juergen Arras, Itzehoe (DE); Anke Hielscher, Köln (DE); Sebastian Engell, Dortmund (DE); Afaq Ahmad, Dortmund (DE); Jens Ehlhardt, Duisburg (DE)

(21) Appl. No.: 19/132,512

(22) PCT Filed: Nov. 21, 2023
(86) PCT No.: PCT/EP2023/082616

§ 371 Date: May 23, 2025

(30) Foreign Application Priority Data
Nov. 25, 2022 (EP) 22209645.5

(51) Int. Cl. B01J 19/00; G05B 13/02; G05B 13/04

(52) U.S. Cl. CPC B01J 19/0033; G05B 13/027; G05B 13/04; B01J 2219/00204; B01J 2219/00218; B01J 2219/0022; B01J 2219/00238; B01J 2219/00243

(57) ABSTRACT

The disclosure relates to a method for controlling a distributed control system, which distributed control system is configured for controlling a chemical plant. The is configured is configured for a chemical production process training set of data points is generated. Generating the training set of data points includes applying at least one analytic function, which at least one analytic function represents a steady-state model and links variables of the chemical production process. The data points correspond to variable values of the linked variables. A black box model is trained with the training set of data points. An objective function is defined on optimization variables, which optimization variables are at least partially comprised by the linked variables, which objective function defines an optimum for the optimization variables. Variable constraints are defined which apply to the linked variables.

### CROSS-REFERENCE TO RELATED APPLICATIONS

This application is the United States national phase of International Patent Application No. PCT/EP2023/082616 filed Nov. 21, 2023, and claims priority to European Patent Application No. 22209645.5 filed Nov. 25, 2022, the disclosures of which are hereby incorporated by reference in their entireties.

### BACKGROUND

### Technical Field

The invention is directed at a method for controlling a distributed control system, which is configured for controlling a chemical plant.

### Description of Related Art

In the operation of chemical plants, which in turn are controlled by a respective interface denoted as distributed control system, there are often either positive effects to be maximized or negative effects to be minimized. For example, it is often desired to maximize the conversion efficiency of some conversion process or to minimize deteriorating effects in the individual components of chemical plants, such as fouling in heat exchangers, which can arise from e.g. a suboptimal steam pressure distribution. Such an optimization is often necessary in real-time. For such processes for which an optimization is sought, there is often an analytic representation of the process underlying the positive or negative effect. That is, the basic mechanisms of the process are known analytically and therefore it is known in principle which variable values on the local scale of the chemical plant lead to a better or worse result. However, since the chemical plant in its entirety is a very complex and large-scale system, the variables in that local scale usually cannot be controlled independently. In other words, the dependence of the local-scale variables to the (control) inputs of the distributed control system of the chemical plant remain, as well as the inter-dependence of these variables with each other, complex and such that not all variables can be simultaneously set to arbitrary values. Thus, the appropriate input to the distributed control system of the chemical plant that is suitable to optimize the desired effect remains elusive but may be determined in a real-time optimization (RTO).

### SUMMARY

Consequently, the object of the invention is to provide a method for controlling a distributed control system, which method permits a more precise determination, without a large number of experiments, of (control) inputs to the distributed control system which are suitable to achieve some desired condition in the plant that is controlled by the distributed control system. Such a desired condition may relate to specific material properties of a substance produced by the plant or some other quantity associated with the operation of the plant, for example the amount and quality of waste resulting from the operation of the plant or some deterioration rate of the plant itself due to its operation. Such inputs vary over time due to uncontrolled influences on the plant (disturbances).

With respect to the method for controlling a distributed control system, the object of the invention is achieved by a method for controlling a distributed control system with the aim to determine optimal set points for a chemical plant which is controlled by the distributed control system, such method having the features as described herein.

The invention is based on the realization that a steady-state model which is based on first principles to describe particular chemical or physical relations of the process may be combined with data that is provided by a distributed control system for a chemical plant-either a control system for a real chemical plant or for a simulated plant in the form of an operator training simulator (OTS)—in order to arrive at a solution of the optimization problem. In contrast to conventional RTO schemes, the invention does not directly apply the steady-state model, because the solution time for a large-scale model is often too high and the convergence to a solution is sometimes not guaranteed, which excludes the usage of RTO. Instead, the steady-state model is employed to generate data points that serve to train a black box model. This is advantageous over generating data points from the real chemical plant or the OTS, because it is less time consuming and the production process as well as the training activities are not interrupted. In addition, an objective function as well as constraints to the variables that reflect physical or chemical boundary conditions are provided defining the optimization problem together with the black-box model. The optimization process is iterative and in each iteration, the variables provided by the distributed control system-more precisely, by the entity to which the distributed control system provides the interface—are used in the optimization problem and hereafter variables determined in the optimization, i.e. set-points, are applied to the distributed control system. Since the black box model and the entity behind the distributed control system, i.e. the real or simulated plant, are not identical, a mismatch in the variables between the two arises in each iterative step. This mismatch is used to modify not only the objective function that underlies the optimization, but also the constraints that are defined with respect to the (process) variables. The black box model, on the other hand, is not adapted in the iteration.

The method according to the invention is a distributed control system with the aim to determine optimal set points for the distributed control system, wherein the distributed control system is configured for controlling a chemical plant, wherein the chemical plant is configured for a chemical production process. That chemical production process can be any kind of chemical production process. In particular, the chemical production process may be a process for the production of methylene diphenyl diisocyanate (MDI).

In the method according to the invention, a training set of data points is generated, wherein generating the training set of data points comprises applying at least one analytic function, which at least one analytic function represents a steady-state model and links variables of the chemical production process. In the steady-state model, all state variables, i.e. all variables related to the state of the system, are assumed to be constant in time. It is preferred that the at least one analytic function is based on respective first principles. Further, the at least one analytic function may represent a respective rigorous first-principle steadystate model. Such first principles present fundamental equations describing physical and/or chemical reactions or phenomena. In other words, the at least one analytic function is based on first principles in that it is not based on an analytic representation of a function that was fitted to e.g. measured data from a production process in the chemical plant. However, the analytic function may be an analytic function that was measured independently of the production process in e.g. a specific lab environment. This applies for instance to data points for specific substances from textbooks, data bases and the like. Variables of the chemical production process can be arbitrary quantities, parameters or settings associated with the chemical production process which are of a chemical, physical or technical nature.

The at least one analytic function links the variables in that the variables are comprised by either the domain or the codomain of the at least one analytic function. In principle, there may be an arbitrary number of analytic functions. Due to the complexity of the chemical production process, the at least one analytic function may comprise 100 or more analytic functions each partially representing a steady-state model and linking variables of the chemical production process. Thus, all of the analytic functions taken together represent the steady-state model. In particular, it may be that the at least one analytic function may comprise at least 1000 analytic functions- or even at least 100.000 analytic functions—each partially representing a steady-state model and linking variables of the chemical production process. The at least one analytic function may be comprised in a commercially available software product for simulating a steadystate process model, e.g. the AVEVA Process Simulation (Aveva Group) or Aspen Plus (AspenTech).

Preferably, the at least one analytic function also links constants of the chemical production process. Such constants may comprise physical or chemical constants such as a Young's modulus, or an electrical resistance, Henry's law constant or the activation energy in the Arrhenius equation.

Further in the method according to the invention, the data points correspond to variable values of the linked variables. In other words, the data points represent sets of variable values of the linked variables that conform to the at least one analytic function. The data points may therefore be generated by the at least one analytic function.

In the method according to the invention, a black box model is trained with the training set of data points. A black box model is a mathematical model implemented in software with stimuli inputs and output reactions. It is a black box model in the sense that the internal working is not interpretable and not directly modifiable other than by training. The behavior of the black box model is determined—and the model thereby modified—by training the black box model with training data. The training data is generated by solving the steady-state model comprising the at least one analytic function, preferably a large number of analytic functions, i.e. the training data for the black-box may be calculated data provided by a commercially available process simulator software.

In the method according to the invention, an objective function is defined on optimization variables, which optimization variables are at least partially comprised by the linked variables, which objective function defines an optimum for the optimization variables, wherein variable constraints are defined which apply to the optimization variables. The objective function may also be called loss function or cost function and permits to quantify the degree of optimization that is reached. In other words, the aim of the optimization is to minimize or maximize-depending on the definition of the objective function—the result of the objective function. The optimization variables are a subset of the linked variables. The optimization variables may also be identical to the linked variables. The variable constraints present boundary conditions that the linked variables- and therefore also at least some of the optimization variables-must adhere to. In principle, the variable constraints may correspond to arbitrary kinds of boundary conditions for the linked variables. In particular, variable constraints and boundary conditions are not restricted to defining value ranges for specific variables. They may also be more complicated and, for example, specify that the sum, product or other calculation result of a group of variables be in a value range. The extent of that value range may in turn be dependent on variables. Other kinds of constraints may also be considered. The objective function together with the variable constraints may be understood to together present the optimization problem.

Further in the method according to the invention, the following iteration steps are repeated to arrive at input variables for controlling the distributed control system with the aim to determine optimal set points: applying input variables to the distributed control system, obtaining process values for at least some of the linked variables from the distributed control system, determining a mismatch between the obtained process values and the values for the linked variables according to the black box model, modifying the objective function based on the determined mismatch, modifying the variable constraints based on the determined mismatch, generating new input variables based on the modified objective function and the modified variable constraints.

The distributed control system is an interface for controlling a chemical plant. The distributed control system provides process values for at least some of the linked variables when input variables are applied. It may be that process values for all of the linked variables are obtained from the distributed control system. Preferably, the process values are dynamic values. In other words, for the process values state variables are considered to be variable- and therefore not to be constant—in time. The distributed control systems in particular provides dynamic process values for the linked variables when input variables are applied. Preferably, the plant process variables are obtained from the distributed control system when the chemical production process has reached a steady state. The distributed control system may be comprised either by a real chemical plant or by an operator training simulator, i.e. a computer-based simulation of a chemical plant. In other words, even though the distributed control system is the interface to a dynamic process, before obtaining the plant process variables it is waited until the dynamic process has reached a steady state. In general, the distributed control system-either as part of a real chemical plant or of an operator training simulator-will be pre-existing and it will not be necessary to develop it specifically for optimizing the objective function, i.e. for solving the object of the present invention. The black box model only needs to represent the steady state and is thus not very computationally intensive. Hence, the black box model may be applied in the optimization and iteratively with the pre-existing distributed control system.

The mismatch between the obtained process values and the values for the linked variables according to the black box model may be determined by comparing the obtained process values and the values for the linked variables. If the process values are not obtained for all of the linked variables, the mismatch is only determined for those linked variables for which the process values are in fact obtained.

The iteration steps may in principle be repeated an arbitrary number of times. In particular, they may be repeated until the objective function crosses a pre-defined boundary or until the difference in the objective function from one iteration to the next crosses a pre-defined boundary or falls below a pre-defined threshold. The new input variables may be generated by any optimization algorithm based on the modified objective function and the modified variable constraints. Preferably, the new input variables are obtained by an interior point method. Any other suitable approach may also be employed.

In a preferred embodiment, the black box model comprises a neural network. Such a neural network has been found to be a particularly useful kind of black box model for representing nonlinear relationships between variables.

In a further preferred embodiment, the distributed control system is represented by an operator training simulator. The operator training simulator also comprises a dynamic process model for the chemical plant, wherein the dynamic process model involves at least some of the linked variables and wherein the values for at least some of the linked variables are obtained from the operator training simulator. The use of an operator training simulator makes it possible to execute the method according to the invention in a pure computing environment without having to rely on an actual chemical plant. The results, however, can be transferred to the chemical plant represented by the operator training simulator.

A further preferred embodiment is characterized in that the distributed control system is connected to a real chemical plant and that the values for at least some of the linked variables are obtained from the real chemical plant. The process values obtained from a real chemical plant represent more valid data than data from a computer simulation.

A further preferred embodiment is characterized in that modifying the objective function comprises adding an objective gradient correction term to the objective function.

In a preferred embodiment, modifying the variable constraints comprises adding a constraint bias term to the variable constraints. Preferably, modifying the variable constraints comprises also adding a constraint gradient term to the variable constraints.

A further preferred embodiment is characterized in that the objective function is configured to minimize steam pressures. This minimization may relate to an arbitrary number of locations at which the steam pressure is minimized. The minimization may be based on an in principle arbitrary metric for considering the steam pressure at different locations, for example by adding the steam pressure values at those locations. Preferably, the objective function is configured to minimize steam pressures thereby minimizing fouling in heat exchangers, in particular of the chemical plant. Thus, the metric underlying the minimization may be based on equations describing the fouling in heat exchangers as a function of steam pressure.

In a preferred embodiment, the objective function is configured to distribute a steam energy input such as to equalize fouling. It is known that a higher steam energy input corresponds to a higher rate of fouling. Thus, when current fouling at a predefined set of locations is equal, the steam energy input at these locations is also to be equal. If, however, there is more fouling and in particular severe fouling at some of the locations of the predefined set of locations, the steam energy input at these locations with more or severe fouling is reduced so as to arrive at equalized resultant fouling at all locations of the predefined set of locations. The remaining steam energy input may then be distributed evenly over the remaining locations of the predefined set of locations. In this way, the time until excessive fouling needs to be addressed can be maximized. Preferably, the objective function is configured to distribute the steam energy input such as to equalize fouling within a process stage of the chemical plant. Thus, the predefined set of locations for which the equalization of the fouling is strived for are all located within the same process stage.

A preferred embodiment is characterized in that the linked variables, preferably the optimization variables, comprise steam pressure variables and in particular steam pressure variables of heat exchangers of the chemical plant. Such steam pressure variables may in particular comprise specific steam pressure values at particular locations. For example, these steam pressure variables may comprise steam pressure values within specific heat exchangers of the chemical plant. Each location for which the steam pressure is minimized may be at a respective heat exchanger of the chemical plant.

It may also be that the linked variables, preferably the optimization variables, comprise heat transfer coefficients. In particular, these may be heat transfer coefficients of heat exchangers. These heat transfer coefficients may vary in particular dependent on the current fouling state of the respective heat exchanger.

In a further preferred embodiment, the linked variables comprise process temperature variables. Such process temperature variables may correspond to the respective temperature at respective locations within the chemical plant.

A preferred embodiment is characterized in that the linked variables comprise heat duty variables, in particular heat duty variables of the heat exchangers. Such heat duty variables describe the amount of heat flow.

In a further preferred embodiment, the variable constraints comprise at least one of a steam pressure bound, a constraint that steam can only heat and at least one bound of the total heat transferred. The steam pressure bound defines a maximum steam pressure which is not to be exceeded at one or more specific locations. The constraint that steam can only heat means that steam cannot be used to cool. The bound of total heat transferred defines an upper and lower limit for the total steam energy input at one or more specific locations.

Theoretically, it would be possible to adapt the black box model from one step of the iteration to the next. However, a further preferred embodiment is characterized in that the black box model remains constant through the repeated iteration steps. This reduces the computational load for each iteration.

In a preferred embodiment, the linked variables are divided into input variables and output variables for the black box model. In the case of a neural network, it is further preferred that the neural network comprises a separate neural network model for each output variable. This may lead to greater total accuracy on the part of the neural network.

In principle, each iteration step- and therefore also an entire iteration—may take an amount of time for computation which is arbitrarily long. A preferred embodiment is characterized in that the iteration steps are executed to arrive at input variables for controlling the distributed control system with the aim to obtain optimal set points and preferably also for controlling the chemical plant in real-time. Therefore, the computation for each iteration step is sufficiently quick to permit determining optimal set points for the distributed control system and/or the chemical plant in real-time.

### BRIEF DESCRIPTION OF THE DRAWINGS

Further advantageous and preferred features are discussed in the following description with respect to the Figures. In the following it is shown in

FIG. 1 a schematic illustration of a chemical plant with its distributed control system on which the method according to the invention is executed,

FIG. 2 a schematic illustration of the chemical plant of FIG. 1 with its distributed control system and of an operator training simulator with its distributed control system on which the method according to the invention is respectively executed,

FIG. 3 a schematic illustration of how the iteration steps of the method according to the invention are taken and

FIG. 4a, b a schematic illustration of variable constraints on the linked variables of the method according to the invention before and after modification.

### DETAILED DESCRIPTION

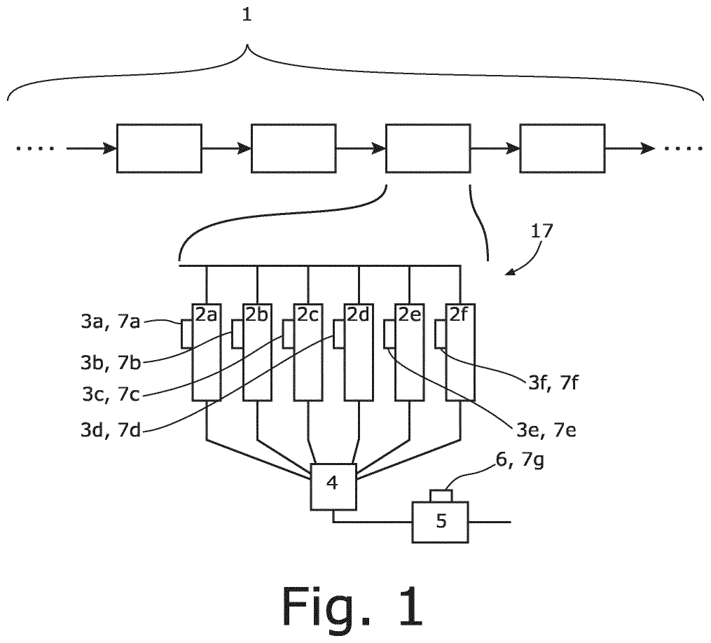

In FIG. 1, a chemical plant 1 is shown which is used for the production of methylene diphenyl diisocyanate (MDI). A single process stage 17 of the chemical plant 1 is shown in more detail. In a simplified description of this process stage 17, the precursor MDA is fed to six towers 2a-f of the chemical plant 1 in parallel for phosgenation. Each tower is heated by tower jackets 3a-f of the chemical plant 1, in which jackets steam is condensed for heat transfer. The respective outlet of each tower 2a-f is fed to a buffer tank 4 of the chemical plant 1 from which it is further fed to a distillation column 5 with a reboiler of the chemical plant 1 with a reboiler jacket 6 in which also steam is condensed for heat transfer. The tower jackets 3a-f and the column jacket 6 present heat exchangers 7a-g of the chemical plant 1. In order to minimize fouling effects, it is desired to minimize the steam pressure in these heat exchangers 7a-g. This leads to the question what the respective temperature setpoints at a respective outlet of the towers 2a-f and at the distillation column 5 should be to achieve such minimized steam pressures.

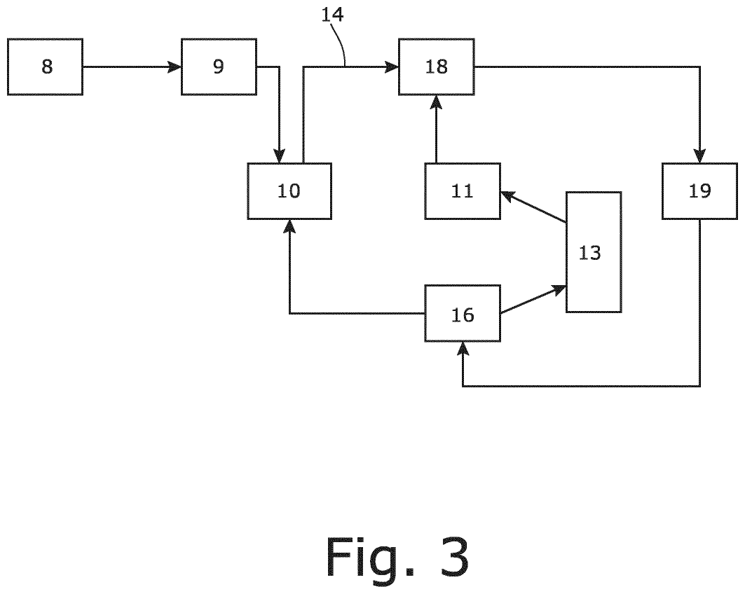

The relationship between the temperature set points and the steam pressures in a steady state is known as a set of equations, which equations correspond to a set of analytic functions representing a steady state model 8 shown in FIG. 3. The steam pressure values, the heat duty variables, the heat transfer coefficients of the heat exchangers and the temperature setpoints may be understood to present variables linked by that steady state model 8. Also known are the applicable constants for these equations, such as the thermal conductivity of the devices involved, which constants are also linked by the steady state model 8 as well as various constraints on the variables linked by these equations. The minimization of the steam pressure values is formulated as an objective function, with the steam pressure values being optimization variables. The heat duty variables present output variables of the steady state model 8. Based on the analytic functions of the steady state model 8, a training set 9 of data points is generated, which training set 9 of data points is then used to train a neural network representing a black box model 10. After training, the black box model 10 stays invariant.

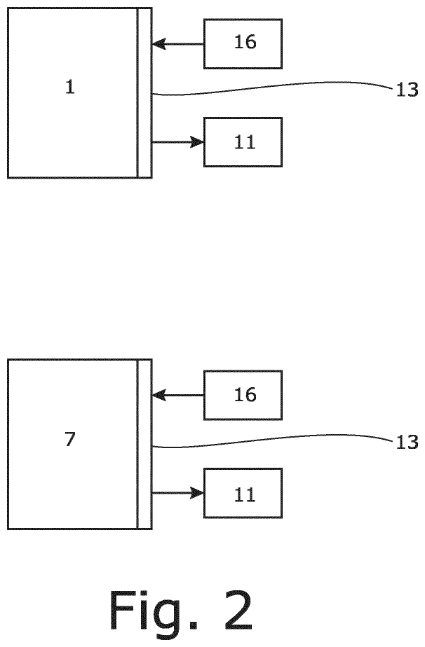

The actual operation of the chemical plant 1 is controlled by a distributed control system 13, shown in FIG. 2, of the chemical plant 1. Besides the chemical plant 1, there is also an operator training simulator 7, also shown in FIG. 2, which provides a simulation for the operation of a chemical plant and also comprises a distributed control system 13 as an interface. In order to maximize its verisimilitude, the operator training simulator 7 is controlled by its distributed control system 13 in the same way as the real chemical plant 1. The temperature setpoints described above are input variables 16 of the distributed control system 13. In other words, desired temperature setpoints may be input to the distributed control system 13 by an operator and then either the appropriate components of the real chemical plant 1 will be adjusted so as to arrive at those desired temperature setpoints or, in the case of the operator training simulator 7, the operator training simulator 7 will simulate an actual chemical plant 1 such that the desired temperature setpoints are arrived at. Furthermore, the distributed control system 13, both of the chemical plant 1 and of the online training simulator 7, will also provide process values 11 of certain quantities as output. These process values 11 also comprise at least some of the linked variables mentioned above, in particular the steam pressures and the heat duty variables.

In the following steps illustrated in FIG. 3, either the distributed control system 13 of the chemical plant 1 or, alternatively, the distributed control system 13 of the operator training simulator 7 may be used throughout, even though both options continue to be cited.

In a first step, an initial set of input variables 16 is applied to the distributed control system 13, either of the chemical plant 1 or of the operator training simulator 7. Once the chemical plant 1 or the operator training simulator 7 has reached a steady state, the process values 11 are obtained from the distributed control system 13.

These process values 11 are now compared to linked variables 14 obtained from the black box model 10, also based on the input variables 16 fed to the black box model 10. Since the relationship between different quantities from the chemical plant 1 or the online training simulator 7 does not exactly match that defined by the black box model 10, there will be a mismatch between the process values 11 and the corresponding values from the black box model 10. Based on this mismatch, both the objective function and the constraints are modified in a modification step 18 in the manner defined below.

In the publication “Iterative set-point optimization of batch chromatography”, W. Gao, S. Engell; Computer & Chemical Engineering 29 (2005) pp. 1401-1409 [Gao2005] the iterative gradient-modification optimization (IGMO) of iterative setpoint optimization is introduced. There it is proposed to not only adapt the cost function but additionally the constraint functions by bias and gradient modifiers. Thereby, the needed plant gradients are estimated by the use of past measurements and finite differences. The method is applied to batch chromatography.

In the article “A reliable modifier-adaptation strategy for real-time optimization”, W. Gao, S. Wenzel, S. Engell; Computer & Chemical Engineering 91 (2016) pp. 318-328 [Gao2016] the modifier adaptation with quadratic approximation is introduced as the extension of IGMO. It combines IGMO with quadratic approximations for gradient estimation and further concepts of derivative free optimization (DFO) such as trust-regions and optimization based on quadratic surrogate models. The method is applied to two case studies taken from the literature.

In the review article “Modifier Adaptation for Real-Time Optimization-Methods and Applications”, A. G. Marchetti, G. Francois, T. Faulwasser, D. Bonvin; Processes 2016, 4, 55 [Marchetti2016] analysis and proofs for the convergence and optimality of modifier adaptation methods in general are presented. It reviews reported variants of modifier adaptation, e.g. the use of higher order modifiers, and discusses important properties and limitations. Finally, it highlights further research directions.

When the minimization of the objective function is given as

$${min}_{u} {J}_{a d}^{( k )} ( u , θ ) ,$$

the modified objective function is defined in each iteration as follows:

$${J}_{a d}^{( k )} ( u , θ ) := {J}_{m} ( u , θ ) + {J}_{p}^{( k )} - {J}_{m}^{( k )} - ( ∇ {J}_{p}^{( k )} - ∇ {J}_{m}^{( k )} ) ( u - {u}^{( k )} ) ,$$

wherein the index “ad” stands for adaptation.

$$∇ {J}_{p}^{( k )} and ∇ {J}_{m}^{( k )}$$

depict the gradients of the objective function with respect to the inputs in the kth-iteration. Thereby, the subscripts m and p denote the available model and the real plant functions respectively. u is the optimized input, whereby u^{(k)} is the last input applied to the system. In addition, affine modifiers are added to the nominal objective function Jₘ(u, θ). The modification comprises both a bias correction term, namely

$${J}_{p}^{( k )} - {J}_{m}^{( k )} ,$$

as well as a gradient correction term, namely

$$( ∇ {J}_{p}^{( k )} - ∇ {J}_{m}^{( k )} ) ( u - {u}^{( k )} )$$

to compensate the mismatch between model and plant functions [Gao2005]. Here and in the following u are the temperature set points and θ are further parameters.

Similarly, when the variable constraint is given as

$${C}_{a d}^{( k )} ( u , θ ) ,$$

the modified constraint is defined as follows

$${C}_{a d}^{( k )} ( u , θ ) := {C}_{m} ( u , θ ) + {C}_{p}^{( k )} - {C}_{m}^{( k )} - ( ∇ {C}_{p}^{( k )} - ∇ {C}_{m}^{( k )} ) ( u - {u}^{( k )} ) .$$

Here the bias term is

$${C}_{p}^{( k )} - {C}_{m}^{( k )}$$

and the gradient term is

$$( ∇ {C}_{p}^{( k )} - ∇ {C}_{m}^{( k )} ) ( u - {u}^{( k )} ) .$$

The experimental plant gradients

$$∇ {J}_{p}^{( k )} and ∇ {C}_{p}^{( k )}$$

may be estimated by the use of finite differences or quadratic approximations, the finite differences and quadratic approximation may be generated based on measurements of the plant/OTS. Additional constraints may be added to enforce a trust-region and restrict the solution of the optimization to lie in a valid domain of the quadratic approximations. [Gao2016] Modifier adaptation is guaranteed to match an optimal point of the real plant under certain assumptions and noise-free conditions. Convergence can be guaranteed leveraging the similarity to trust region-methods. [Marchetti 2016]

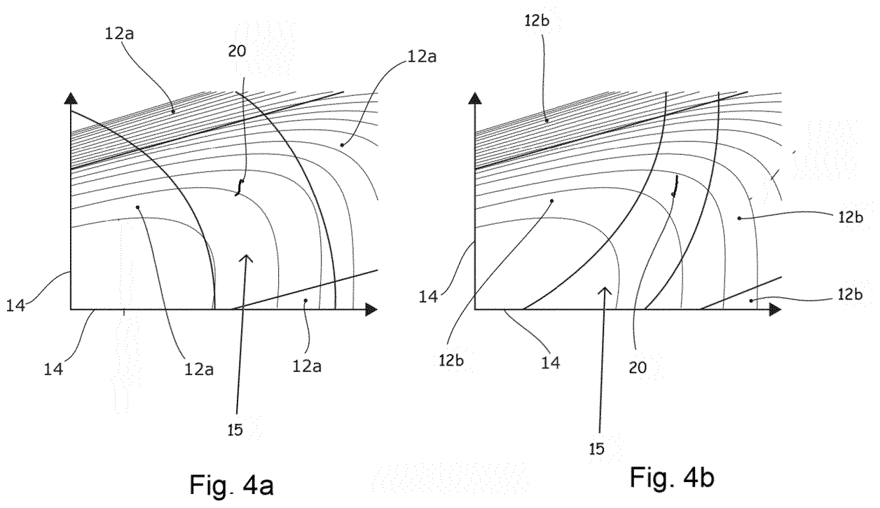

FIG. 4a graphically illustrates variable constraints 12a in the space of the linked variables 14 as set initially, i.e. before the first iteration of the method steps. It is to be noted that, for the sake of illustration, only two dimensions are shown. FIG. 4b shows the same variable constraints 12b according to the operator training simulator 7 for the case in which the operator training simulator 7 is used instead of a real chemical plant 1. Note that the respective areas denoted by the variable constraints 12a, b in the graphical representation denote the space of the linked variables 14 which is not permitted according to the respective variable constraint 12a, b. Thus, the respective space of permitted values 15 corresponds to that space which is outside the space denoted by each variable constraint 12a, b, i.e. the remaining space. Each contour 20 in FIGS. 4a and 4b corresponds to a constant value of the objective function resulting from the variables on that contour. As can be seen, the space of permitted values 15 for the linked variables 14 is different for FIG. 4a and FIG. 4b. Each modification of the constraints as described above leads to an approximation of the constraints as given in FIG. 4b, i.e, by the operator training simulator 7, in a local “cutout” region around the current set of input variables 16 by the modified constraints. The same situation mutatis mutandis arises when a real chemical plant 1 is used instead of an operator training simulator 7.

With this modified objective function and the modified variable constraints, a new set of input variables 16 is arrived at by applying an interior point method 19 to solve the optimization problem consisting of the objective function and the constraints. The steps given above are repeated until a stop criterion is met, for example the convergence of the objective function to a specific value or having the value of the objective function go below a predefined limit value.

1. A method for controlling a distributed control system, which distributed control system is configured for controlling a chemical plant,
wherein the chemical plant is configured for a chemical production process,
wherein a training set of data points is generated,
wherein generating the training set of data points comprises applying at least one analytic function, which at least one analytic function represents a steady-state model and links variables of the chemical production process,
wherein the data points correspond to variable values of the linked variables,
wherein a black box model is trained with the training set of data points, wherein an objective function is defined on optimization variables, which optimization variables are at least partially comprised by the linked variables, which objective function defines an optimum for the optimization variables,
wherein variable constraints are defined which apply to the linked variables,
wherein the following iteration steps are repeated to arrive at input variables for controlling the distributed control system:
applying input variables to the distributed control system,
obtaining process values for at least some of the linked variables from the distributed control system,
determining a mismatch between the obtained process values and the values for the linked variables according to the black box model based on the same input variables,
modifying the objective function based on the determined mismatch,
modifying the variable constraints based on the determined mismatch, and
generating new input parameters based on the modified objective function and the modified variable constraints.

2. The method according to claim 1, wherein the black box model comprises a neural network.

3. The method according to claim 1, wherein the distributed control system is represented by an operator training simulator, that the operator training simulator comprises a dynamic process model for the chemical plant, that the dynamic process model involves at least some of the linked variables and that the values for at least some of the linked variables are obtained from the operator training simulator.

4. The method according to claim 1, wherein the distributed control system is connected to a real chemical plant and that the values for at least some of the linked variables are obtained from the real chemical plant.

5. The method according to claim 1, wherein modifying the objective function comprises adding an objective gradient correction term to the objective function.

6. The method according to claim 1, wherein modifying the variable constraints comprises adding a constraint bias term to the variable constraints, and that modifying the variable constraints comprises adding a constraint gradient term to the variable constraints.

7. The method according to claim 1, wherein the objective function is configured to minimize steam pressures.

8. The method according to claim 1, wherein the objective function is configured to distribute a steam energy input.

9. The method according to claim 1, wherein the linked variables comprise steam pressure variables, in particular steam pressure variables of heat exchangers of the chemical plant.

10. The method according to claim 1, wherien the linked variables comprise process temperature variables.

11. The method according to claim 1, wherein the linked variables comprise heat duty variables.

12. The method according to claim 1, wherein the variable constraints comprise at least one of a steam pressure bound, a constraint that steam can only heat and at least one bound on the total heat transferred.

13. The method according to claim 1, wherein the black box model remains constant through the repeated iteration steps.

14. The method according to claim 1, wherin the linked variables are divided into input variables and output variables for the black box model.

15. The method according to claim 1, wherein the iteration steps are repeated to arrive at input variables for controlling the distributed control system in real-time.

16. The method according to claim 14, wherein that the neural network comprises a separate neural network model for each output variable.

17. The method according to claim 15, wherein the iteration steps are repeated to arrive at input variables for controlling the chemical plant.

18. The method according to claim 11, wherein the heat duty variables comprise heat duty variables of the heat exchangers.

19. The method according to claim 10, wherein that the at least one analytic function also links constants of the chemical production process.

20. The method according to claim 9, wherein the linked variables comprise heat transfer coefficients.
